(19) United States
(12) Patent Application Publication
(10) Pub. No.: US 2016/0358080 A1
(43) Pub. Date: Dec. 8, 2016

(54) PURSUING A FUGITIVE TO A CAPTURE LOCATION

(71) Applicant: MOTOROLA SOLUTIONS, INC., Schaumburg, IL (US)

(72) Inventors: Alejandro G. Blanco, Fort Lauderdale, FL (US); Scott M. Alazraki, Davie, FL (US); Melanie A. King, Hollywood, FL (US); John B. Preston, Plantation, FL (US)

(21) Appl. No.: 14/729,844

(22) Filed: Jun. 3, 2015

(51) Int. Cl. G06N 5/04

(52) U.S. Cl. CPC G06N 5/04

(57) ABSTRACT

A method and system for pursuing a fugitive to a capture location. In one embodiment, the system including a main computer including a cornering strategy module. The main computer configured to communicate with a mapping module, a fugitive tracking and intelligence module, an asset tracking module, and a pursuit asset and receive ingress and egress information from the mapping module; predict a route of the fugitive; identify the capture location based on at least one selected from the group consisting of the received ingress and egress information and the predicted route; determine a cornering strategy based on the capture location and a cornering strategy function; and output instructions, based on the cornering strategy, to a pursuit asset in order to direct the fugitive toward the capture location.

### BACKGROUND OF THE INVENTION

A fugitive fleeing from law enforcement, custody, or both may be tracked and pursued in a variety of ways. For example, a fugitive's known associates may be identified and monitored for potential interactions with the fugitive. In addition, wanted posters may be placed in various locations and distributed via various media in an effort to obtain information from the general public about the fugitive. Known strategies may result in failed capture and dangerous situations between the fugitive and law enforcement. Dangerous situations may also arise between the fugitive and public citizens.

Accordingly, there is a need for improved systems and methods for pursuing a fugitive to a capture location.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system for pursuing a fugitive in accordance with some embodiments.

FIG. 2 is a block diagram of a main computer of the system of FIG. 1 in accordance with some embodiments.

FIG. 3 schematically illustrates a fugitive tracking and intelligence module of the system of FIG. 1 receiving fugitive tracking and intelligence information concerning the fugitive in accordance with some embodiments.

FIG. 4 is a map used by a mapping module of the system of FIG. 1 in accordance with some embodiments.

FIG. 5 is a flow chart illustrating a method for pursuing a fugitive in accordance with some embodiments.

FIG. 6 is a flow chart illustrating an exemplary action carried out by one or more pursuit assets after receiving instructions from the main computer of the system of FIG. 1 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments of the invention provide system for pursuing a fugitive to a capture location, the system including a main computer including a cornering strategy module. The main computer configured to communicate with a mapping module, a fugitive tracking and intelligence module, an asset tracking module, and a pursuit asset and receive ingress and egress information from the mapping module; predict a route of the fugitive; identify the capture location based on at least one selected from the group consisting of the received ingress and egress information and the predicted route; determine a cornering strategy based on the capture location and a cornering strategy function; and output instructions, based on the cornering strategy, to a pursuit asset in order to direct the fugitive toward the capture location.

Another embodiment of the invention provides system for pursuing a fugitive to a capture location. The system including a main computer including a cornering strategy module; a mapping module in communication with the main computer; a fugitive tracking and intelligence module in communication with the main computer; an asset tracking module in communication with the main computer; and a pursuit asset in communication with the main computer and the asset tracking module. The main computer is configured to receive information from at least one selected from the group consisting of the mapping module, the fugitive tracking and intelligence module, and the asset tracking module; predict a route of the fugitive; identify the capture location using the cornering strategy module, the capture location based on at least one selected from the group consisting of the received information, ingress and egress information, and the predicted route; determine a cornering strategy based on the capture location and a cornering strategy function; and output instructions, based on the cornering strategy, to a pursuit asset in order to direct the fugitive toward the capture location.

Yet another embodiment of the invention provides a method for pursuing a fugitive to a capture location. The method including receiving, at a controller, information concerning the fugitive; receiving, at the controller, ingress and egress information; predicting, using the controller, a route of the fugitive; identifying, using the controller, the capture location based on at least one selected from the group consisting of the received information, the received ingress and egress information, and the predicted route; determining, using the controller, a cornering strategy based on the capture location and a cornering strategy function; and outputting instructions, based on the cornering strategy, to a pursuit asset in order to direct the fugitive toward the capture location.

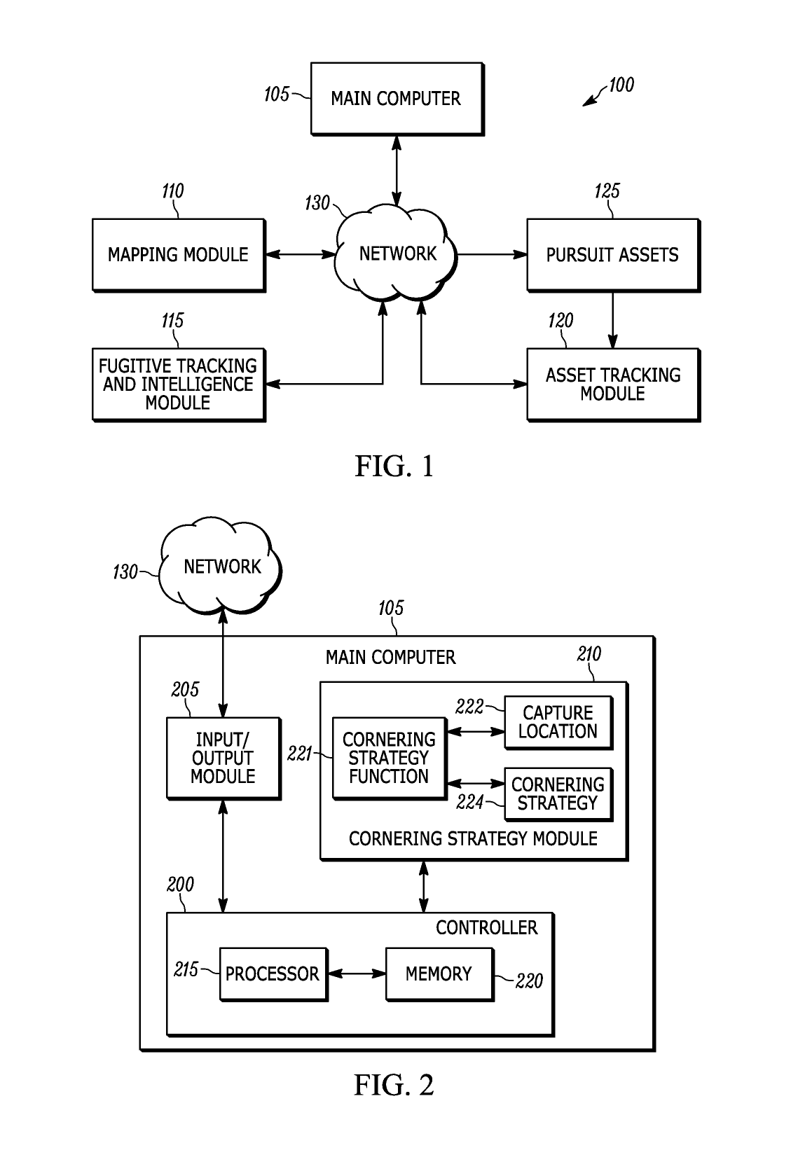

FIG. 1 is a block diagram of a system 100 for pursuing a fugitive. The system 100 may include a main computer 105. The main computer 105 may be communicatively coupled to, and receive information from, a mapping module 110, a fugitive tracking and intelligence module 115, and an asset tracking module 120. The main computer 105 may further be communicatively coupled to and output instructions based on the received information, to one or more pursuit assets 125, described in greater detail below.

Communication between the main computer 105 and various components can occur through a network 130. In some embodiments, the network 130 is, for example, a wide area network (WAN) (e.g., a transport control protocol/internet protocol (TCP/IP) based network, a cellular network, such as, for example, a Global System for Mobile Communications (or Groupe Special Mobile (GSM)) network, a General Packet Radio Service (GPRS) network, a Code Division Multiple Access (CDMA) network, an Evolution-Data Optimized (EV-DO) network, an Enhanced Data Rates for GSM Evolution (EDGE) network, a 3GSM network, a 4GSM network, a Digital Enhanced Cordless Telecommunications (DECT) network, a Digital advanced mobile phone system (AMPS) (IS-136/time division multiple access (TDMA)) network, or an Integrated Digital Enhanced Network (iDEN) network, etc.). In other embodiments, the network 130 is, for example, a local area network (LAN), a neighborhood area network (NAN), a home area network (HAN), or personal area network (PAN) employing any of a variety of communications protocols, such as Wi-Fi, Bluetooth, ZigBee, etc. Other wide area networks, such as land mobile radio (LMR), terrestrial trunked radio (TETRA), and digital mobile radio (DMR) may also be used. In another embodiment, the main computer 105, the mapping module 110, the fugitive tracking and intelligence module 115, and the asset tracking module 120 are combined into a single system. In such an embodiment, the single system is communicatively coupled to the pursuit assets 125 through the network 130.

FIG. 2 is a block diagram of the main computer 105. The main computer 105 includes a controller 200, an input/output module 205, and a cornering strategy module 210. The controller 200 is electrically and/or communicatively connected to a variety of modules or components of the main computer 105. For example, the illustrated controller 200 is connected to the input/output module 205 and the cornering strategy module 210. The controller 200 includes combinations of hardware and software that are operable to, among other things, control the operation of the main computer 105.

In some embodiments, the controller 200 includes a plurality of electrical and electronic components that provide power, operational control, and protection to the components and modules within the controller 200 and/or the main computer 105. For example, the controller 200 includes, among other things, a processor 215 (e.g., a microprocessor, or another suitable programmable device) and a memory 220.

The memory 220 includes, for example, a program storage area and a data storage area. The program storage area and the data storage area can include combinations of different types of memory, such as read-only memory (ROM), random access memory (RAM) (e.g., dynamic RAM (DRAM), synchronous DRAM (SDRAM), etc.), electrically erasable programmable read-only memory (EEPROM), flash memory, a hard disk, a Secure Digital (SD) card, or other suitable magnetic, optical, physical, or electronic memory devices. The processor 215 is connected to the memory 220 and executes software instructions that are capable of being stored in a RAM of the memory 220 (e.g., during execution), a ROM of the memory 220 (e.g., on a generally permanent basis), or another non-transitory computer readable medium such as another memory or a disc. The software may include, one or more applications, program data, filters, rules, one or more program modules, and other executable instructions. The controller 200 is configured to retrieve from memory and execute, among other things, instructions related to the control processes and methods described herein. In other constructions, the controller 200 includes additional, fewer, or different components.

The input/output module 205 provides communication link between the main computer 105 and the network 130. Thus, the main computer 105 can communicate with the mapping module 110, the fugitive tracking and intelligence module 115, the asset tracking module 120, and the pursuit assets 125 via the network 130. Communications through the network 130 can be protected using one or more encryption techniques, such as those techniques provided in the Institute of Electrical and Electronic Engineers (IEEE) 802.1 (www.ieee802.org/1/) standard for port-based network security, pre-shared key, Extensible Authentication Protocol (EAP), Wired Equivalency Privacy (WEP), Temporal Key Integrity Protocol (TKIP), Wi-Fi Protected Access (WPA), etc. The connections between the input/output module 205 and the network 130 are, for example, wired connections, wireless connections, or a combination of wireless and wired connections. In some embodiments, the main computer 105 or the input/output module 205 include one or more communications ports (e.g., Ethernet, serial advanced technology attachment (SATA), universal serial bus (USB), integrated drive electronics (IDE), etc.) for transferring, receiving, or storing data associated with the system 100.

The cornering strategy module 210 receives information (through the network 130, input/output module 205, and controller 200) from the mapping module 110, the fugitive tracking and intelligence module 115, and the asset tracking module 120. The cornering strategy module 210 uses the received information, along with a cornering strategy function 221, to determine a capture location 222 and a cornering strategy 224. The capture location 222 and cornering strategy 224 may, for example, include data (e.g., geographic coordinates) and instructions and be stored in memory or, as shown in FIG. 2, form part of the cornering strategy module 210. The capture location 222 is a location to which the fugitive is directed where the factors favoring capture of the fugitive (for example, ease of capture, reduced ability to escape, and safety of law enforcement) are higher or better than other locations. The cornering strategy 224 is used to direct the fugitive to the capture location 222. In some embodiments, the cornering strategy function 221 uses one or more decision trees to determine the capture location 222 and the cornering strategy 224. In another embodiment, the cornering strategy function 221 uses a rule-based system to determine the capture location 222 and the cornering strategy 224. In yet another embodiment, the cornering strategy function 221 weights the various received information in order to determine the capture location 222 and the cornering strategy 224. In such an embodiment, the received information may be weighted based on the type of information received. For example, the types of received information may include, but is not be limited to, points of egress in an area (e.g., streets, windows, doors, etc.), population of an area (e.g., least inhabited areas are weighted more), time of day, day of the week, special events occurring in an area, existence or amount of uninhabited buildings in an area, if an area is a busy consumer area (e.g., a retail shopping center), if the area is hazardous (e.g., a construction site or the location of an industrial manufacturing area), and lack of familiarity of an area to the fugitive (e.g., a rating based on whether the location is known to have been visited by the fugitive in the past).

In some embodiments, the cornering strategy module 210 is implemented in whole or in part in software. In some embodiments, there is no separate module (e.g., cornering strategy module 210), but rather the cornering strategy 224 is implemented using software stored on the memory 220 of the controller 200 and executed by the processor 215 of the controller 200.

The cornering strategy 224 is used to affect the movements and actions of the fugitive. More particularly, in certain embodiments, the fugitive is directed toward the capture location 222 as a result of the main computer 105 providing instructions, based on the cornering strategy 224, to the pursuit assets 125. The pursuit assets 125 use the instructions to direct the fugitive toward the capture location 222. As indicated, the capture location 222 is a location where the odds of successfully capturing the fugitive are enhanced, in comparison to current capture methods. In addition, in certain embodiments, the capture location is also a location where the odds of a safe capture are also enhanced (i.e., the probability of injury to law enforcement and the general public is reduced).

In some embodiments, the mapping module 110, the fugitive tracking and intelligence module 115, and the asset tracking module 120 include substantially similar components to the main computer 105. In other embodiments, the mapping module 110, the fugitive tracking and intelligence module 115, and the asset tracking module 120 include more or less components than the main computer 105.

As indicated above, the mapping module 110 provides the map information to the main computer 105 to be used by the cornering strategy module 210. More particularly, the mapping module 110 provides information based on analysis of one or more maps such as, for example, one or more outdoor maps or one or more indoor maps (e.g., architectural drawings, floor plans, etc.). In some embodiments, the maps are of locations known to the fugitive. The mapping module 110 analyzes the outdoor maps and the indoor maps to determine map information relating to, among other things, ingress points of a plurality of areas, egress points of a plurality of areas, heavy populated areas, hazardous areas, and widths of pathways. The mapping module 110 may use additional information, such as but not limited to, time of day, day of week, occurrence of special events, and amount of light (e.g., sunlight and artificial light) when analyzing an area. In some embodiments, time of day, day of week, special event, and similar information may be used to determine how populated an area may be. For example, if a sporting event is scheduled for a certain day, then the streets near the stadium holding the event may be assumed to be populated with foot traffic, vehicular traffic, or both. In another example, certain areas during business hours may experience a high level of foot traffic, such as an entrance to an office building experiencing a high level of foot traffic at 8:00 AM or 5:00 PM during business days (for example, Monday through Friday). Egress points may be potential points of exit that a fugitive may take while evading capture. Ingress points may be potential points of entry for the fugitive and the pursuit assets 125.

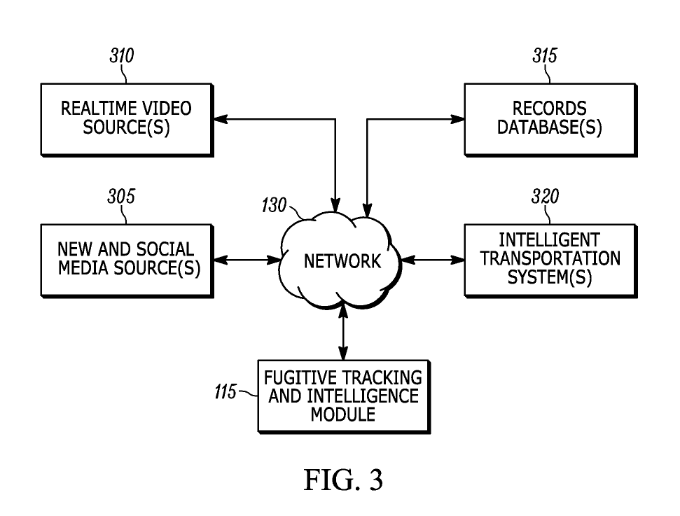

FIG. 3 is a block diagram illustrating the fugitive tracking and intelligence module 115 receiving fugitive tracking and intelligence information from a number of sources. The fugitive tracking and intelligence information may include, among other things, information from news and social media sources 305, real-time video sources 310, one or more records databases 315, and one or more intelligent transportation systems 320. The information and data from the news and social media sources 305, real-time video sources 310, the records databases 315, and intelligent transportation systems 320 may be provided through a network, for example the network 130. In other embodiments, the fugitive tracking and intelligence module 115 may receive information from the news and social media sources 305, real-time video sources 310, and intelligent transportation systems 320 through other networks and communication links, including but not limited to, the Internet. News and social media sources 305 may include without limitation, news websites, televisions stations, radio stations (e.g., frequency modulation (FM) radio, amplitude modulation (AM) radio, satellite radio, Internet radio, etc.), and social media websites (e.g., Facebook, Twitter, MySpace, Instagram, etc.). Real-time video sources 310 may include, without limitation, fixed cameras (e.g., closed-circuit televisions (CCTVs), surveillance cameras, traffic enforcement cameras, etc.), aerial cameras (e.g., news helicopters, police helicopters, etc.), body-worn cameras (e.g., police body-worn cameras, etc.), vehicular cameras (e.g., police vehicle cameras, etc.), and Internet streaming cameras (e.g., webcams, etc.). The records databases 315 may include records that can provide historical information concerning the fugitive and other individuals. For example, the records databases 315 may include records collected from previous fugitive pursuits, records related to wanted criminals, records related to the criminal histories of the fugitive and known associates of the fugitive, and court records. The intelligent transportation systems 320 may use sources including, but not limited to, vehicle navigation and telematics systems, traffic signal control systems, automatic license plate recognition systems, and public transportation tracking systems. As indicated above, the fugitive tracking and intelligence module 115 provides the fugitive tracking and intelligence information to the main computer 105. In turn, the fugitive tracking and intelligence information is used by the cornering strategy module 210.

The asset tracking module 120 monitors the pursuit assets 125. The pursuit assets 125 include, but are not limited to, law enforcement personnel (e.g., police officers on foot), law enforcement vehicles (e.g., police automobiles (manual and autonomous automobiles), police helicopters, etc.), unmanned aerial vehicles (i.e., drones), traffic lights, automated gate closure apparatus, automated tire puncture apparatus, and automated road block apparatus. The asset tracking module 120 determines pursuit asset information based on monitoring the location and status of each of the pursuit assets 125. The location of the pursuit assets 125 may be tracked using, among other things, satellite navigation tracking (e.g., global navigation satellite system (GNSS) tracking, global positioning system (GPS) tracking, Galileo tracking, Indian Regional Navigation Satellite System (IRNSS) tracking, GLObal NAvigation System (GLONAS) tracking, BeiDou Navigation Satellite System, etc.) and cellular telephone tracking (e.g., triangulation, network-based tracking, handset-based tracking, subscriber identification module (SIM) based tracking, WiFi-based tracking, etc.). The status of the pursuit assets 125 may include, among other things, a pursuit status (e.g., if the pursuit asset is currently in pursuit of fugitive) and an operational status (e.g., if a pursuit asset is parked at a garage, stopped at a traffic light, traveling on a highway, etc.). As noted, the asset tracking module 120 provides the pursuit asset information to the main computer 105.

The main computer 105 can send instructions to the pursuit assets 125 to pursue the fugitive according to the cornering strategy 224. The instructions may be used by the pursuit assets 125 to, among other things, close off routes so the fugitive is directed to a capture location 222 and to navigate to the capture location 222.

In some embodiments, the instructions are turn-by-turn directions (e.g., directions to a location or directions to follow or travel on a predetermined route). The turn-by-turn directions may be continuously presented to the user in the form of spoken, visual, or combined spoken and visual directions. In such an embodiment, the turn-by-turn directions may be sent to a navigation unit located within a vehicle. The turn-by-turn directions may then be followed by police personnel traveling in the vehicle. In another embodiment, the turn-by-turn directions may be sent to a personal or hand-held device (e.g., smart telephone, tablet, laptop, heads-up display, head-mounted glasses, worn vibration devices (e.g., wristwatches, vests, etc.), audio devices, etc.). In such an embodiment, the law enforcement personnel may use the hand-held device to follow the turn-by-turn directions while on foot. In another embodiment, the instructions are route instructions, which may be sent to a self-driving vehicle. In yet another embodiment, the instructions are coordinates (e.g., longitudinal and latitudinal coordinates), sent to aerial pursuit assets 125 (e.g., helicopters, unmanned aerial vehicles, drones, etc.). In yet another embodiment, the instructions are operational instructions. In such an embodiment the operational instructions may be, among other things, speed instructions, hold instructions, traffic light operational instructions, deploy gate closure instructions, deploy tire deflator instructions, and deploy road block instructions.

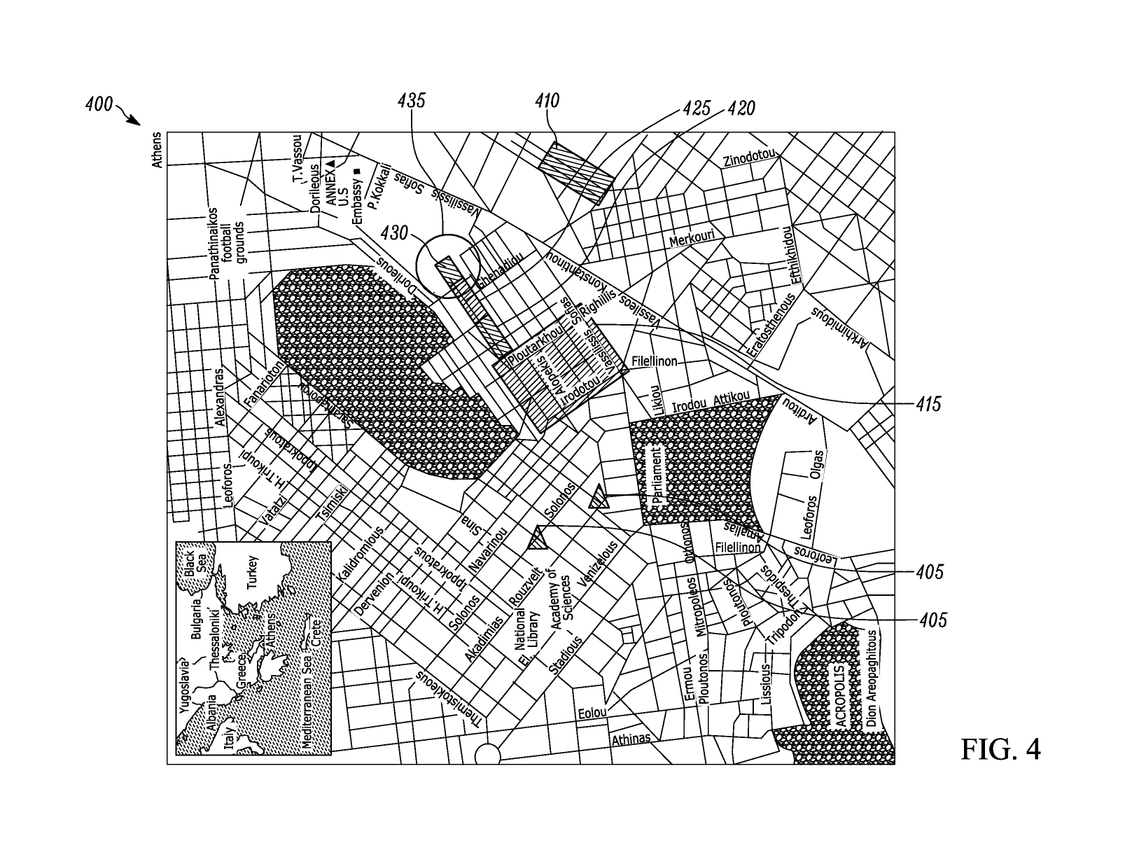

FIG. 4 is an exemplary map 400 that may be used by the cornering strategy module 210. The exemplary map 400 is used by the cornering strategy module 210 to determine the capture location 222 and cornering strategy 224. The map 400 includes one or more fugitive-known locations 405. The fugitive-known locations 405 may be locations known to the fugitive such as current or prior addresses at which the fugitive lives or lived. In addition, the fugitive-known locations 405 may include addresses of known associates of the fugitive. The map 400 also includes a plurality of areas that may be a capture location 222. In FIG. 4, five potential capture locations are shown and include a first potential capture location 410, a second potential capture location 415, a third potential capture location 420, a fourth potential capture location 425, and a fifth potential capture location 430. In other embodiments, the system 100 may identify a different number of areas as potential capture locations. In the example map 400, the system 100, using the cornering strategy module 210, determines that the first potential capture location 410 is a hazardous industrial area (e.g., an industrial manufacturing site), the second potential capture location 415 is a heavily trafficked area during work or business days, the third potential capture location 420 has many egress points, the fourth potential capture location 425 has some egress points, and the fifth potential capture location 430 has few egress points. The cornering strategy module 210, using information from one or more of the mapping module 110 (for example information concerning ingress and egress points), the fugitive tracking and intelligence module 115, and the asset tracking module 120, determines that the fifth potential capture location 430, as a result of being at a non-hazardous site, having less traffic, and having few egress points, is the best potential capture location 222.

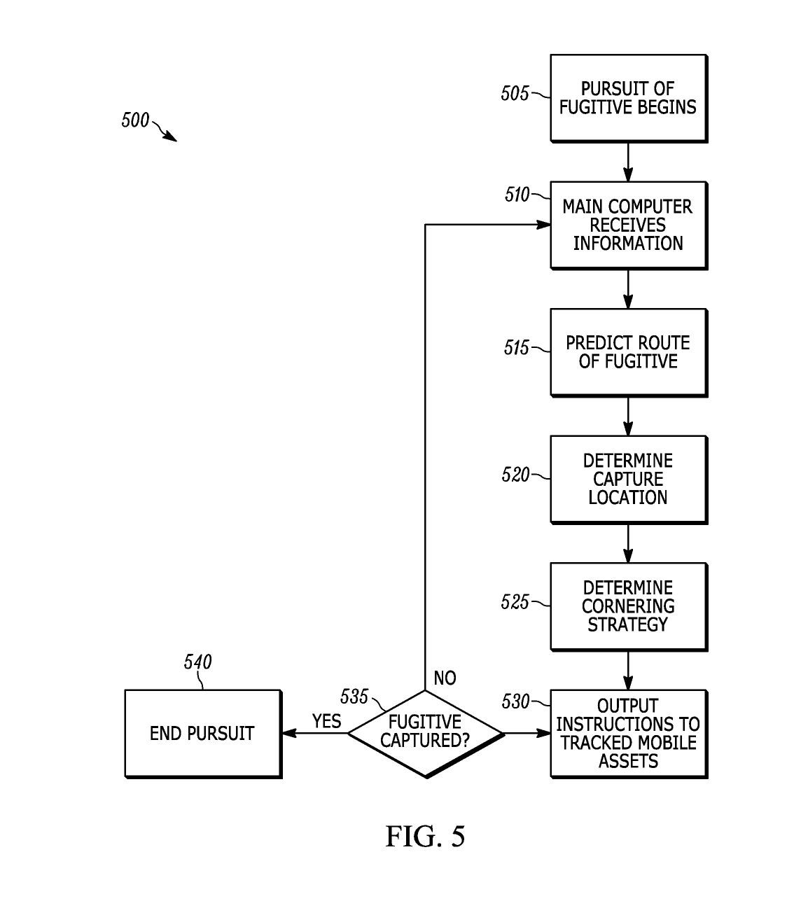

FIG. 5 is a flowchart illustrating an exemplary method 500 for pursing a fugitive and generating a cornering strategy 224. Pursuit of the fugitive begins (Step 505). The main computer 105 receives information from the mapping module 110, the fugitive tracking and intelligence module 115, and the asset tracking module 120 (Step 510). The main computer 105 uses the received information to predict a route of the fugitive (Step 515). The cornering strategy module 210 uses the information, along with the cornering strategy function 221, to determine a capture location 222 (Step 520). The cornering strategy module 210 uses the cornering strategy function 221 to determine a cornering strategy 224 (Step 525). The main computer 105 outputs instructions to the pursuit assets 125 (Step 530). The instructions to the pursuit assets 125 include instructions for directing the fugitive toward the capture location 222. As is described further below, the instructions sent to the pursuit assets 125 can include instructions to close off points of egress and other routes so the same are not available to the fugitive, as well as instructions to navigate to the capture location 222. A determination is then made as to whether the fugitive has been captured or not (Step 535). For example, the determination may be made based on feedback from the pursuit assets 125 (for example, a radio transmission of “suspect captured.”). When the fugitive has been captured, pursuit is ended (Step 540). When the fugitive has not been captured, the method 500 returns to Step 510 and the process is repeated. In the repeat process, a new capture location may be determined.

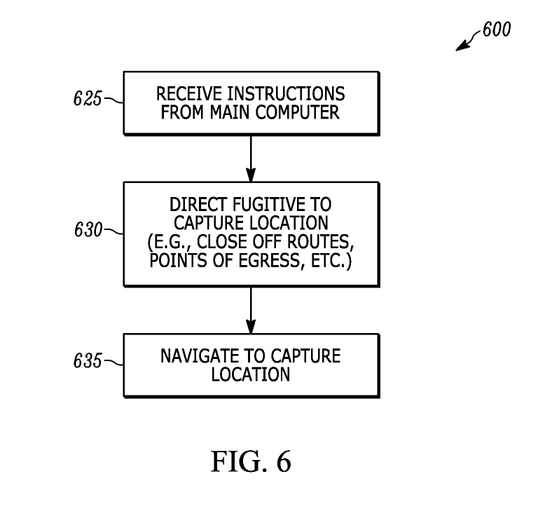

FIG. 6 is a flowchart illustrating an exemplary action, in the form of a method 600, carried out by the pursuit assets 125 after receiving instructions from the main computer 105. The actions or steps in method 600, may for example, take place between steps 530 and 535 of method 500.

The pursuit assets 125 receive instructions from the main computer (Step 625). The pursuit assets use the instructions to direct the fugitive to the capture location 222. (Step 630). This may be achieved, for example, by closing points of egress or other escape routes (for example, blocking a street with a vehicle, locking doors, etc.). At least some of the pursuit assets 125 also navigate (as, for example, described above in Paragraph 0028) to the capture location 222 (Step 635).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system for pursuing a fugitive to a capture location, the system comprising:
a main computer including a cornering strategy module,
the main computer configured to
communicate with a mapping module, a fugitive tracking and intelligence module, an asset tracking module, and a pursuit asset and receive ingress and egress information from the mapping module;
predict a route of the fugitive;
identify the capture location based on at least one selected from the group consisting of the received ingress and egress information and the predicted route;
determine a cornering strategy based on the capture location and a cornering strategy function; and
output instructions, based on the cornering strategy, to a pursuit asset in order to direct the fugitive toward the capture location.

2. The system of claim 1, wherein the cornering strategy function weights the received information based on the received information being one of a type selected from the group consisting of points of egress in an area, population of an area, time of day, day of the week, occurrence of special events, amount of uninhabited buildings in an area, if an area is a busy consumer area, if the area is hazardous, and lack of familiarity of an area to the fugitive.

3. The system of claim 1, wherein the information includes map information.

4. The system of claim 1, wherein the information includes fugitive tracking and intelligence information.

5. The system of claim 4, wherein the fugitive tracking and intelligence information includes at least one selected from the group consisting of news, social media, real-time video, records databases, and intelligent transportation data.

6. The system of claim 1, wherein the information includes pursuit asset information.

7. A system for pursuing a fugitive to a capture location, the system comprising:
a main computer including a cornering strategy module;
a mapping module in communication with the main computer;
a fugitive tracking and intelligence module in communication with the main computer;
an asset tracking module in communication with the main computer; and
a pursuit asset in communication with the main computer and the asset tracking module;
wherein, the main computer is configured to
receive information from at least one selected from the group consisting of the mapping module, the fugitive tracking and intelligence module, and the asset tracking module;
predict a route of the fugitive;
identify the capture location using the cornering strategy module, the capture location based on at least one selected from the group consisting of the received information, ingress and egress information, and the predicted route;
determine a cornering strategy based on the capture location and a cornering strategy function; and
output instructions, based on the cornering strategy, to a pursuit asset in order to direct the fugitive toward the capture location.

8. The system of claim 7, wherein the cornering strategy function weights the received information according to at least one selected from the group consisting of points of egress in an area, population of an area, time of day, day of the week, occurrence of special events, amount of uninhabited buildings in an area, if an area is a busy consumer area, if the area is hazardous, and lack of familiarity of an area to the fugitive.

9. The system of claim 7, wherein the information includes map information.

10. The system of claim 7, wherein the information includes fugitive tracking and intelligence information.

11. The system of claim 10, wherein the fugitive tracking and intelligence information includes at least one selected from the group consisting of news, social media, real-time video, records databases, and intelligent transportation data.

12. The system of claim 7, wherein the information includes pursuit asset information.

13. The system of claim 12, wherein the pursuit asset information includes at least one selected from the group consisting of a location of a pursuit asset and a status of a pursuit asset.

14. The system of claim 7, wherein the pursuit asset is at least one selected from the group consisting of police personnel, a vehicle, a self-driving vehicle, an unmanned aerial vehicles, a traffic light, an automated gate closure apparatus, an automated tire puncture apparatus, and an automated road block apparatus.

15. The system of claim 7, wherein the instructions include at least one selected from the group consisting of turn-by-turn directions, route directions, coordinates, and operational instructions.

16. A method for pursuing a fugitive to a capture location, the method comprising:
receiving, at a controller, information concerning the fugitive;
receiving, at the controller, ingress and egress information;
predicting, using the controller, a route of the fugitive;
identifying, using the controller, the capture location based on at least one selected from the group consisting of the received information, the received ingress and egress information, and the predicted route;
determining, using the controller, a cornering strategy based on the capture location and a cornering strategy function; and
outputting instructions, based on the cornering strategy, to a pursuit asset in order to direct the fugitive toward the capture location.

17. The method of claim 16, wherein the cornering strategy function weights the received information according to at least one selected from the group consisting of points of egress in an area, population of an area, time of day, day of the week, occurrence of special events, amount of uninhabited buildings in an area, if an area is a busy consumer area, if the area is hazardous, and lack of familiarity of an area to the fugitive.

18. The method of claim 16, wherein the information includes map information.

19. The method of claim 16, wherein the information includes fugitive tracking and intelligence information.

20. The method of claim 19, wherein the fugitive tracking and intelligence information includes at least one selected from the group consisting of news, social media, real-time video, records databases, and intelligent transportation data.

21. The method of claim 16, wherein the information includes pursuit asset information.

22. The method of claim 21, wherein the pursuit asset information includes at least one selected from the group consisting of a location of a pursuit asset and a status of a pursuit asset.

23. The method of claim 16, wherein the pursuit asset is at least one selected from the group consisting of police personnel, a vehicle, a self-driving vehicle, an unmanned aerial vehicles, a traffic light, an automated gate closure apparatus, an automated tire puncture apparatus, and an automated road block apparatus.

24. The method of claim 16, wherein the instructions include at least one selected from the group consisting of turn-by-turn directions, route directions, coordinates, and operational instructions.
